(19) United States
(12) Patent Application Publication
(10) Pub. No.: US 2012/0195806 A1
(43) Pub. Date: Aug. 2, 2012

(54) Solar Floater

(76) Inventor: Tim Mulvihill, Plano, TX (US)

(21) Appl. No.: 13/018,422

(22) Filed: Feb. 1, 2011

(51) Int. Cl. B01D 11/02

(52) U.S. Cl. 422/265

(57) ABSTRACT

A A solar powered floatable chlorinating apparatus consisting of a floatable chamber which receives and contains the chlorine medium and dispenses solubilized chlorine into water entering into and dispersing from the chamber. Solar powered lights, operably associated with the floatable chamber, lights up the lid of the device while floating in the water.

### FIELD OF THE INVENTION

This invention relates to an illuminated, solar powered device for dispensing a soluble solid source of chlorine or other halogen in a spa, hot tub or swimming pool.

### BACKGROUND OF THE INVENTION

Water in swimming pools, spas, hot tubs, and the like can become contaminated with algae and similar organisms. The contaminant growth is usually controlled by the addition of chlorine to the water. The amount of chlorine required to maintain the water is in a substantially organism-free state depends on the size of the pool or spa, the climatic conditions, the temperature of the water, and the extent of use of the pool or spa. The hot water found in spas and hot tubs necessitates the frequent addition of chlorine, because the material added rapidly loses effectiveness. A device that can be placed in the water to dispense chlorine in controlled amounts relieves the spa owner of the necessity of regularly monitoring and maintaining the chlorine content of the water.

Chlorine dispensing devices exist for swimming pools. One such device, among many, is the Rainbow Plastics Model 330 floating dispenser for solid chlorine. This dispenser resembles an inverted hollow truncated cone. The interior serves as a receptacle into which granular pellets of water-soluble chlorine material are placed. Around the circumference of the receptacle adjacent to the bottom there are apertures consisting of elongated vertical slots. The slots cooperate with a similarly slotted sleeve around the exterior of the container. The sleeve can be adjusted so that the slots are fully closed, fully opened, or in between. The top of the receptacle is closable by a lid. The walls of the container are hollow and are filled with closed-cell plastic foam. The cavity in which the foam is located is hermetically sealed. When filled with a soluble solid source of chlorine or bromine ions and floated in a swimming pool, the pool water contacts the source material in the receptacle to dissolve the source material, thereby releasing the active constituent of the material into the water. The rate at which such solution and release occurs is regulated by the extent to which the apertures in the receptacle are opened or closed by the position of the adjustment sleeve on the exterior of the receptacle. This dispenser is not conveniently usable in a spa because the effective size of the apertures cannot be regulated precisely enough to prevent the dispenser from over-chlorinating the spa water which, by reason of its temperature, acts more rapidly on the source material than the usually cooler water in a swimming pool. Also, this dispenser has a relatively large capacity for containing the source material so that, even when its apertures are very nearly closed, substantial quantities of source material are wetted and dissolved.

Other prior art products include cumbersome floating structures, each receiving slow dissolving chlorine tablets or the like.

However, a need exists for a floating chlorine dispensing unit which is illuminated at night by solar energy during the day. Such a device would be entertaining in the evening hours and functional.

Current chlorine floaters are not solar L.E.D light equipped and do not have the lid shaped to maximize light dispersion.

### SUMMARY OF THE INVENTION

It is thus an object of the invention to provide a colored plastic dispensing base which can hold 3″ chlorine tabs. Clear plastic twist on lid which contains solar cells, battery and two white or colored led lights. This dispensing unit is waterproof design and shaped like flying saucer.

It is a further object of the invention to provide colored or white led bulbs enclosed in a molded and patterned clear plastic lid with rechargeable battery and solar cells

### BRIEF DESCRIPTION OF DRAWINGS

N/A

### DETAILED DESCRIPTION OF DRAWINGS

N/A

I claim:

1. A solar floater comprised of;
a chlorinating dispensing bottom tray, solar energy collecting cells, battery and LED lights.

2. A solar floater of claim 1 wherein the lids are solar powered with rechargeable batteries and LED lights on a floating chemical dispenser.

3. A solar floater of claim 1 wherein the removable lid is constructed with a clear center section in the patterned plastic lens to maximize charging of 1.2 volt battery.

4. A solar floater of claim 1 wherein the clear plastic lens has a distinct pattern of 17 overlapping arches to diffuse the Led lights giving a glowing appearance.

5. A solar floater of claim 1 wherein the base of the lid has 2 locking tabs to securely attach the removable lid to folding dispenser base when twisted on.

6. A solar floater of claim 1 wherein the lid has a seal to waterproof the on/off switch is located on the bottom of the lid.

7. A solar floater of claim 1 wherein the lights are available in white, blue, green, purple, red, orange and multicolor versions.

8. A solar floater of claim 1 wherein the LED lights are configured in solid or color changing.

9. A solar floater of claim 1 wherein the lid is removable to allow 3 inch chlorine tablets, and other chemicals to be added to folded dispenser.

10. A solar floater of claim 1 wherein the lens is ultrasonically sealed to the lid/light base to insure watertight seal.

11. A solar floater of claim 1 wherein the overall appearance of the product resembles flying saucer/UFO descriptions.
